(19) United States
(12) Patent Application Publication
(10) Pub. No.: US 2014/0167935 A1
(43) Pub. Date: Jun. 19, 2014

(54) SYSTEM AND METHOD FOR APPLIANCE REMOTE CONTROL IDENTIFICATION

(71) Applicant: GENERAL ELECTRIC COMPANY, Schenectady, NY (US)

(72) Inventor: Kyle Robert Eden, Louisville, KY (US)

(73) Assignee: GENERAL ELECTRIC COMPANY, Schenectady, NY (US)

(21) Appl. No.: 13/719,407

(22) Filed: Dec. 19, 2012

(51) Int. Cl. G08B 5/36

(52) U.S. Cl. CPC G08B 5/36
USPC 340/12.54

(57) ABSTRACT

Systems and methods for appliance remote control identification are provided. An exemplary method includes receiving, at the appliance, an operational command message from a remote control device which instructs the appliance to perform an operation. The method further includes obtaining an identification attribute associated with the remote control device. Further, the identification attribute is presented on a display of the appliance. An exemplary system includes an exemplary appliance having a user interface including a display, a controller, and a remote device interface. The exemplary system further includes a network and a plurality of remote control devices.

### FIELD OF THE INVENTION

The present disclosure relates generally to the identification of appliance remote control devices. More particularly, an identification attribute associated with a remote control device can be presented on a display of an appliance.

### BACKGROUND OF THE INVENTION

Remote control technology enables a user of an appliance to control the operation of the appliance from a remote location. For example, an infrared controller may be able to send an operational command to an appliance from across a room or other similar distance. More recent advances have allowed remote control of an appliance over a local network, such as a home area network, or even a wide area network, such as the Internet. Thus, the ability of a user of an appliance to interact with and control the appliance remotely has greatly expanded.

However, such expanded ability also brings unique new problems. In particular, when a plurality of users can each control an appliance, either remotely or at the appliance itself, there can be confusion regarding who is controlling the appliance at any given time. For example, a first user in a remote location can remotely control the appliance to perform a first operation. A second, subsequent user can directly interact with the appliance to control the appliance to perform a second operation. However, the second user cannot determine who is controlling the appliance by what device. The second user is left with the undesirable option of interrupting an unknown user's first operation or failing to perform the second user's desired second operation. Thus, a need exists for improved identification of remote users of an appliance.

### BRIEF DESCRIPTION OF THE INVENTION

Aspects and advantages of the invention will be set forth in part in the following description, or may be obvious from the description, or may be learned through practice of the invention.

One exemplary aspect is directed to a method for presenting an identification attribute associated with a remote control device on a display of an appliance. In particular, an operational command message from a remote control device can be received at the appliance. The operational command message can instruct the appliance to perform an operation. An identification attribute associated with the remote control device can be obtained. Further, the identification attribute can be presented on the display of the appliance. In such fashion, a clear indication of the current usage state of the appliance can be provided.

Another exemplary aspect is directed an appliance comprising a user interface, a remote device interface, and a controller. The user interface can include a display and the remote device interface can be configured to receive an operational command message from a remote control device. The operational command message can instruct the appliance to perform an operation. Further, the controller can be configured to obtain an identification attribute associated with the remote control device and present the identification attribute on the display.

Another exemplary aspect is directed to a method for operating an appliance. In particular, a first operational command message can be received from a first remote control device. The first operational command message can instruct the appliance to perform a first operation. Further, a second operational command message can be received from a second remote control device. The second operational command message can instruct the appliance to perform a second operation. A priority between the first and second remote control devices can be determined at the appliance and either the first operation or the second operation can be performed according to the priority.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary appliance and associated remote control devices according to an exemplary embodiment of the present disclosure; and

FIGS. 2A and 2B provide a flow chart of an exemplary method according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for appliance remote control identification. More particularly, an identification attribute associated with a remote control device can be presented on a display of the appliance. For example, an operational command message can be sent to the appliance by a remote control device. The operational command message can instruct the appliance to perform an operation. After receiving the operational command message, the appliance can obtain an identification attribute associated with the remote control device and present the identification attribute on the display. The appliance can present the identification attribute on the display throughout performance of the operation. In such fashion, a clear indication of the current usage state of the appliance can be provided.

The identification attribute can be a title or other identifier associated with the remote control device. As another example, the identification attribute can identify a user of the remote control device. The use of identification attributes provides for easier identification of the remote control device or user remotely controlling the appliance.

In one implementation, the identification attribute associated with the remote control device can be obtained from data contained within the operational command message. In another implementation, the identification attribute can be obtained by accessing a device identifier database storing a plurality of identification attributes associated with a plurality of remote control devices.

The operational command message can further schedule a time at which the operation should be performed. The scheduled time can optionally be presented on the display in conjunction with the identification attribute. The operational command message can further contain text data inputted by a user of the remote control device and the text data can optionally be presented on the display in conjunction with the identification attribute.

In another aspect, a direct contact user can override a remote control user. Allowing a direct contact user to override a remote control user provides for safer operation of the appliance.

Further aspects of the present disclosure relate to determining a priority between two operational command messages. In particular, an appliance can respectively receive first and second operational command messages from first and second remote control devices which respectively instruct the appliance to perform first and second operations. The appliance can determine a priority between the first and second remote control devices. Either the first operation or the second operation can be performed based upon the priority. Information indicative of the priority can be presented on the appliance display.

The appliance can determine a priority between first and second remote control devices based upon priority data accessed from a device priority database. Further, the appliance can modify the priority data stored in the device priority database based upon instructions received via a user interface.

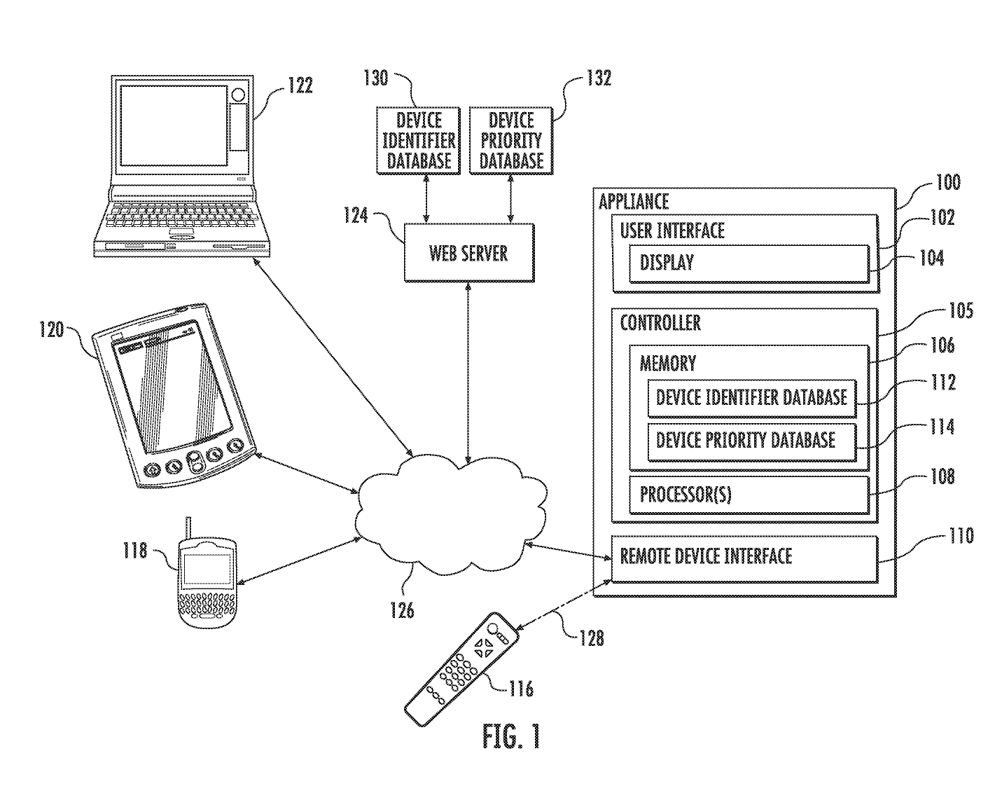

FIG. 1 depicts an exemplary appliance 100 and associated remote control devices according to an exemplary embodiment of the present disclosure. Appliance 100 can have a user interface 102 which includes a display 104. Appliance 100 can further have a controller 105 and a remote device interface 110. Controller 105 can include a memory 106 and a processor 108. Memory 106 can include or be in communication with one or more databases, such as device identifier database 112 and device priority database 114. Processor 108 can be one processor or can be a plurality of processors which are operably connected.

Remote device interface 110 can be configured to send and receive messages according to a plurality of communication protocols and transmission techniques. Remote device interface 110 can be configured to communicate with remote control devices 118, 120, 122, and 124 over a network 126. Network 126 can be a LAN, WAN, or other suitable network or combination of networks and can include any number of wired or wireless links.

Remote device interface 110 can also be configured to communicate with a remote control device directly, such as remote control device 116. As such, remote device interface 110 can include a number of various sensors, transmitters, antennas, or other suitable communications components. For example, remote device interface 110 can include an infrared sensor and transmitter. As another example, remote device interface 110 can communicate using radio frequency communications, Bluetooth, ZigBee, or any other suitable protocol or transmission technique. Appliance 100 can perform operations based upon operational command messages received from remote control devices 116, 118, 120, 122, and 124.

As one of ordinary skill in the art will understand, in light of the disclosures contained herein, remote control devices 116, 118, 120, 122, and 124 can take many various forms. For example, remote control device 116 can be a device which transmits an operational command message 128 to appliance 100, via remote device interface 110, using infrared pulses, radio frequency communications, Bluetooth, ZigBee, or any other suitable protocol or transmission technique. As an example, remote control device 116 can be a home energy manager. As further examples, remote control device 118 can be a smartphone and remote control device 120 can be a tablet computer. Smartphone 118 and tablet computer 120 can remotely control appliance 100 by sending operational command messages over a home area network, through electronic mail, using SMS technology, or other suitable protocols or transmission techniques.

As yet another example, a personal computer 122 or other web-enabled device, such as tablet computer 120, can access a web service which sends operational command messages to appliance 100 using a web server 124. For example, personal computer 122 can access, via network 126, a web-service for remotely controlling appliance 100. After logging in, the user of personal computer 122 can request that an operational command message be sent to appliance 100. Web server 124 can be associated with the web service and can send the operational command message to appliance 100 via network 126. Such web service can be accessed using a web browser or an application customized for the specific web-enabled device.

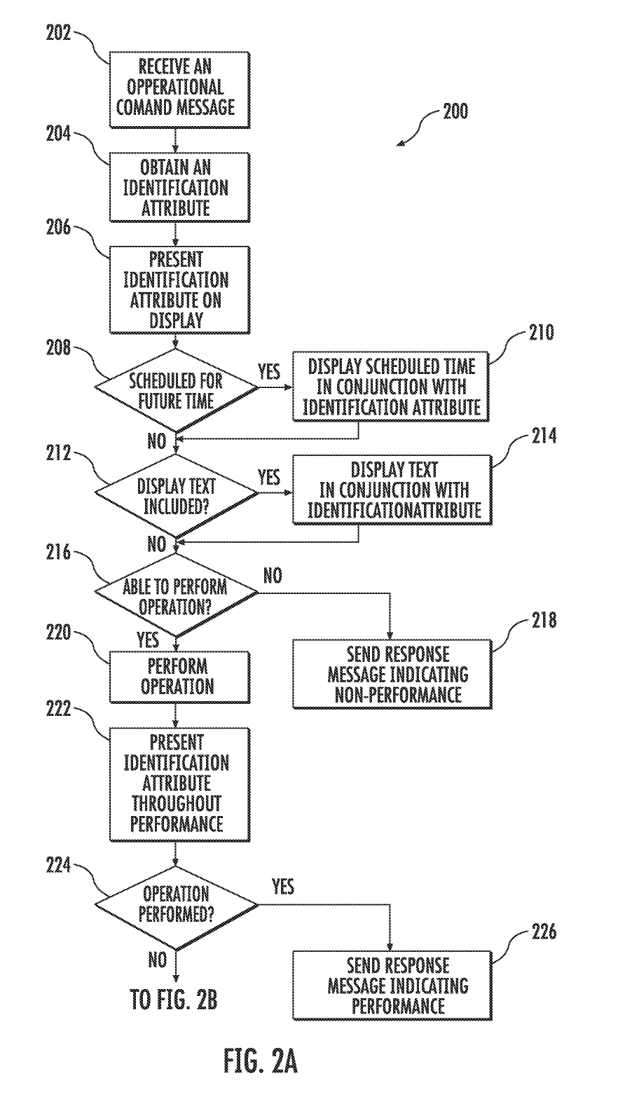

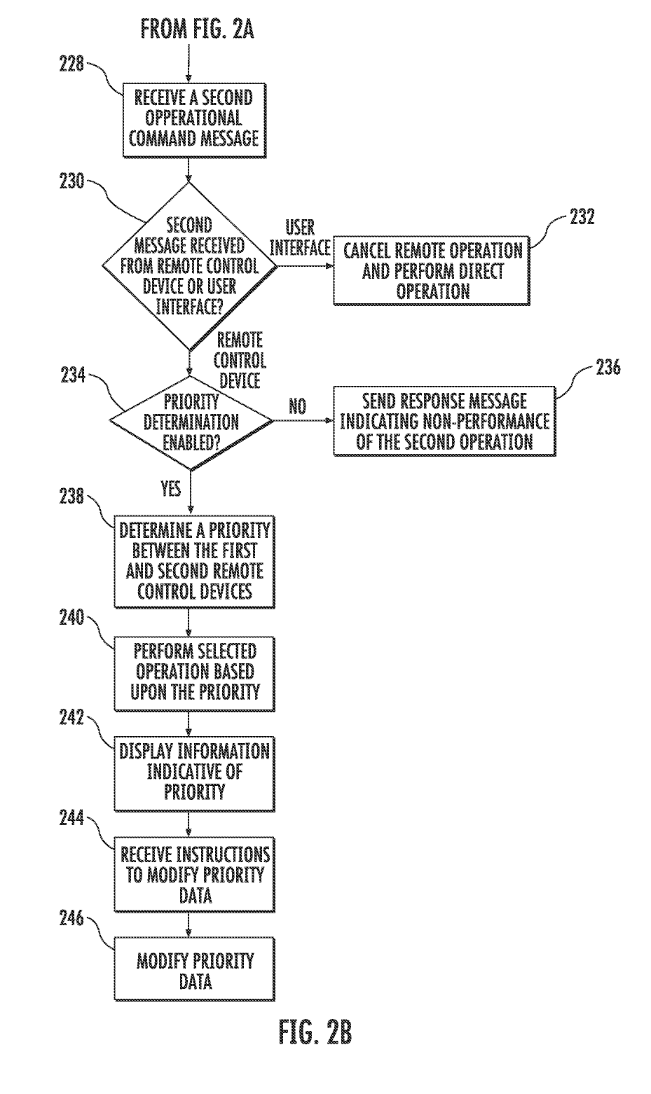

FIGS. 2A and 2B depict a flow chart of an exemplary method (200) according to an exemplary embodiment of the present disclosure. The exemplary method (200) can be implemented using any suitable appliance, including appliance 100 of FIG. 1. In addition, although FIGS. 2A and 2B depict steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

Referring to FIG. 2A, at (202) an operational command message can be received from a remote control device. The operational command message can instruct the appliance to perform an operation. For example, with reference to FIG. 1, appliance 100 can receive operational command message 128, via remote device interface 110, directly from remote control device 116. Alternatively, appliance 100 can receive operational command messages from remote control devices over network 126.

Returning to FIG. 2A, at (204) an identification attribute associated with the remote control device can be obtained. For example, the identification attribute can be a title associated with the remote control device, such as “Kyle's Tablet.” As another example, the identification attribute can be an IP address assigned to the remote control device. As yet another example, the identification attribute can be a telephone number associated with a smartphone. One of ordinary skill in the art, in light of the disclosures contained herein, will understand that many various identification attributes can be associated with a remote control device. Any form of identification attribute which serves to identify the remote control device or the remote control device user is within the scope of the present disclosure.

In one implementation, the identification attribute can be information contained in a user profile associated with a user of the remote control device. For example, a plurality of remote control devices, such as a tablet computer and a smartphone, can both be owned by the same user and a user profile can be associated with the user. As another example, the user can login to a web service using a username associated with the user profile and the web service can provide remote control access to the appliance.

The user profile can contain information which identifies the individual, such as the individual's name, or otherwise renders the individual available for contact, such as a telephone number or electronic mail address. If the user controls the appliance with a remote control device associated with his user profile, then the appliance can obtain and display data associated with the individual's user profile rather than simply identifying the remote control device. The use of user profiles in this fashion more accurately identifies the remote operator of the appliance.

In one implementation, the identification attribute associated with the remote control device can be obtained from data contained within the operational command message. For example, the identification attribute can be included within the first data packet sent from the remote control device to the appliance. As another example, the identification attribute can be included within an operational command message sent to the appliance by the web server.

As yet another example, the operational command message can generally include an identifier such as a reference ID, unique passcode, IP address, or other suitable identifier which identifies the remote control device to the appliance. The appliance can use the identifier to obtain the identification attribute. Alternatively, the identifier itself can be the identification attribute.

In another implementation, the identification attribute can be obtained by accessing a device identifier database storing a plurality of identification attributes associated with a plurality of remote control devices. For instance, the device identifier database can store identification attributes associated with each remote control device eligible to control the appliance. The appliance can access the device identifier database and obtain a specific identification attribute based upon an identifier such as a reference ID, unique passcode, IP address, or other suitable identifier.

The device identifier database can be stored in a local memory or a remote device. For example, memory 106 of appliance 100 of FIG. 1 can include or be in communication with device identifier database 112. Identification attributes can be programmed into device identifier database 112 automatically or manually using user interface 102. Device identifier database 112 can be accessed when the appliance receives an operational command message. Alternatively, the device identifier database can be device identifier database 130 accessed over network 126. For example, web server 124 can provide remote access to device identifier database 130.

Returning to FIG. 2A, at (206) the identification attribute can be presented on a display of the appliance. For example, the identification attribute can be presented on display 104 of appliance 100 of FIG. 1. Presenting the identification attribute on display 104 can provide for a clear indication of the current usage state of appliance 100.

Returning to FIG. 2A, at (208) the appliance can check whether the operational command message further schedules a time at which the operation should be performed. If yes, then at (210) the scheduled time can be presented in conjunction with the identification attribute on the display. Presenting a scheduled operation on the display can allow for a remote user to reserve or otherwise notify direct contact users of a desired future operation.

At (212) the appliance can check whether the operational command message further contains text data inputted by a user of the remote control device. If yes, then at (214) the text data can be presented in conjunction with the identification attribute on the display. Presenting user-inputted text data on the display can allow for custom messages to accompany a current or future scheduled operation. Such text data can inform direct contact users of a specific purpose for a remotely commanded operation.

At (216) the appliance can check whether it is able to perform the commanded operation. If the appliance is unable to perform the operation, then at (218) a response message can be sent to the remote control device which indicates non-performance of the commanded operation. If the appliance is able to perform the commanded operation, then at (220) the appliance can perform the operation.

At (222) the identification attribute can be presented on the display throughout performance of the operation. Presenting the identification attribute in such manner can provide a direct contact user with the identity of the remote control device or user who has commanded the operation currently being performed by the appliance.

At (224) the appliance can check whether the operation has been performed or completed. If yes, then at (226) the appliance can send a response message to the remote control device which indicates successful performance of the commanded operation. If, at (224), the operation has not yet been completed, then the appliance can continue performing the operation.

Referring now to FIG. 2B, at (228) a second operational command message can be received while the appliance is still performing the first operation. At (230) the appliance can check whether the second operational command message was received from a remote control device or from a direct contact user via a user interface of the appliance.

If it is determined at (230) that the second operational command message was received from a direct contact user via a user interface of the appliance, then at (232) the first operation commanded by the remote control device can be cancelled and the second operation commanded by the direct contact user can be performed. Allowing a direct contact user to override a remote control user can provide for safer operation of the appliance. In addition, the direct contact user can identify the remote user or remote control device due to the identification attribute presented on the display and can contact the remote control user if desirable.

If it is determined at (230) that the second operational command message was received from a second remote control device, then at (234) the appliance can check whether a priority determination is enabled. For example, a user of the appliance can adjust user settings controlling the behavior of the appliance. One user setting can control whether or not the appliance performs a priority determination upon receiving a plurality of operational command messages. If a priority determination is not enabled, for example according to user settings, then at (236) a response message can be sent to the second remote control device which indicates non-performance of the second operation and the appliance can continue performing the first operation.

If it is determined at (234) that a priority determination is enabled, then at (238) the appliance can determine a priority between the first and second remote control devices. In one implementation, the appliance can determine a priority between first and second remote control devices based upon priority data accessed from a device priority database. The priority data can rank the priority of remote control devices. Alternatively, the priority data can be a priority value associated with a remote control device and the appliance can compare priority values.

The device priority database can be stored in a local memory or on a remote device. For example, with reference to FIG. 1, device priority database 114 can be contained within or in communication with appliance memory 106 and can store priority data associated with remote control devices 116, 118, 120, 122, and 124. Alternatively, the device priority database can be device priority database 132 accessed by communicating with web server 124 over network 126.

Returning to FIG. 2B, at (240) the appliance can perform a selected operation based upon the priority determined between the first and second remote control devices. For example, if it is determined at (238) that the first remote control device has a higher priority than the second remote control device, then the first operation can be performed at (240). If the inverse is determined at (238), then the second operation can be performed at (240).

Likewise, at (242) information indicative of the priority can be presented on the display. For example, if it is determined at (238) that the first remote control device has a higher priority than the second remote control device, then a first identification attribute associated with the first remote control device can be displayed at (242). If the inverse is determined at (238), then a second identification attribute associated with the second remote control device can be displayed at (242). Alternatively or additionally, other forms of information indicative of the priority can be presented on the display, including, without limitation, priority rankings or priority values.

At (244) the appliance receives, via the user interface, instructions to modify priority data stored in the device priority database. At (246) the appliance modifies the priority data. For example, the priority ranking associated with a remote control device can be modified based upon the instructions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for presenting an identification attribute associated with a remote control device on a display of an appliance, the method comprising:
receiving, at the appliance, an operational command message from a remote control device, the operational command message instructing the appliance to perform an operation;
obtaining an identification attribute associated with the remote control device; and
presenting the identification attribute on the display of the appliance.

2. The method of claim 1, wherein receiving an operational command message comprises receiving, via a network, an operational command message from a web server.

3. The method of claim 1, wherein the identification attribute identifies a user of the remote control device.

4. The method of claim 1, wherein the identification attribute associated with the remote control device is obtained from data contained within the operational command message.

5. The method of claim 1, wherein obtaining the identification attribute associated with the first remote control device comprises accessing a device identifier database storing a plurality of identification attributes associated with a plurality of remote control devices.

6. The method of claim 1, wherein the identification attribute is obtained from a web server over a network.

7. The method of claim 1, wherein the operational command message further schedules a time at which the operation should be performed, the method further comprising presenting the scheduled time on the display in conjunction with the identification attribute.

8. The method of claim 1, wherein the operational command message further contains text data inputted by a user of the remote control device, the method further comprising presenting the text data on the display in conjunction with the identification attribute.

9. The method of claim 1, wherein obtaining an identification attribute associated with the remote control device comprises:
obtaining an identifier associated with the remote control device; and
using the identifier to obtain the identification attribute associated with the remote control device.

10. The method of claim 1, wherein the method further comprises performing the operation, the identification attribute being presented on the display throughout performance of the operation.

11. The method of claim 1, wherein receiving, at the appliance, an operational command message from a remote control device comprises:
receiving, at the appliance, a first operational command message from a first remote control device, the first operational command instructing the appliance to perform a first operation; and
receiving a second operational command message from a second device, the second operational command message instructing the appliance to perform a second operation.

12. The method of claim 11, further comprising:
determining, at the appliance, a priority between the first and second remote control devices; and
performing either the first operation or the second operation according to the priority.

13. An appliance comprising:
a user interface, the user interface including a display;
a remote device interface configured to receive an operational command message from a remote control device, the operational command message instructing the appliance to perform an operation; and
a controller, the controller being configured to obtain an identification attribute associated with the remote control device and present the identification attribute on the display.

14. The appliance of claim 13, wherein the controller is configured to obtain the identification attribute associated with the remote control device from data contained within the operational command message.

15. The appliance of claim 13, wherein the controller is configured to obtain the identification attribute by accessing a device identifier database storing a plurality of identification attributes associated with a plurality of remote control devices.

16. The appliance of claim 15, wherein the controller is configured to access the device identifier database by communicating, via the remote device interface, with a web server over a network.

17. The appliance of claim 13, wherein:
the operational command message further schedules a time at which the operation should be performed; and
the controller is further configured to present the scheduled time on the display in conjunction with the identification attribute.

18. A method for operating an appliance, the method comprising:
receiving a first operational command message from a first remote control device, the first operational command message instructing the appliance to perform a first operation;
receiving a second operational command message from a second remote control device, the second operational command message instructing the appliance to perform a second operation;
determining, at the appliance, a priority between the first and second remote control devices; and
performing either the first operation or the second operation according to the priority.

19. The method of claim 18, wherein the method further comprises presenting, on a display of the appliance, information indicative of the priority between the first and second remote control devices.

20. The method of claim 18, wherein the priority between the first and second remote control devices is determined based upon priority data accessed from a device priority database, the method further comprising:
receiving, via a user interface of the appliance, instructions to modify the priority data stored in the device priority database; and modifying the priority data stored in the device priority database.
